(19) United States
(12) Patent Application Publication
(10) Pub. No.: US 2022/0390575 A1
(43) Pub. Date: Dec. 8, 2022

(54) METHOD AND APPARATUS FOR DETERMINING AN INTENSITY VALUE REPRESENTING AN INTENSITY OF LIGHT REFLECTED FROM AN OBJECT IN A SCENE

(71) Applicant: Infineon Technologies AG, Neubiberg (DE)

(72) Inventors: Armin Josef SCHOENLIEB, Seiersberg-Pirka (AT); Hannes PLANK, Graz (AT)

(73) Assignee: Infineon Technologies AG, Neubiberg (DE)

(21) Appl. No.: 17/828,236

(22) Filed: May 31, 2022

(30) Foreign Application Priority Data
Jun. 2, 2021 (DE) 102021114295.4

(51) Int. Cl. G01S 7/4861; G01S 17/89; G01S 7/4865

(52) U.S. Cl. CPC G01S 7/4861; G01S 17/89; G01S 7/4865

(57) ABSTRACT

A method for determining an intensity value representing an intensity of light reflected from an object in a scene is provided. The method includes performing a Time-of-Flight (ToF) measurement of the scene using a ToF sensor. A light-intensity-independent correlation function of a photo-sensitive pixel of the ToF sensor exhibits a plateau in a target measure-ment range for the ToF measurement. The object is located within the target measurement range. The method further includes determining the intensity value based on an output of the photo-sensitive pixel for the ToF measurement.

### FIELD

The present disclosure relates to intensity sensing for Time-of-Flight (ToF) sensors. In particular, examples relate to a method and an apparatus for determining an intensity value rep-resenting an intensity of light reflected from an object in a scene.

### BACKGROUND

A conventional ToF camera measures distance by emitting near infrared light. In various applications such as face recognition, the detailed depth is not the primary measurement target. A greyscale image indicating the amount of reflected light is more important. For example, this image may be generated by integrating the received light into one of the charge buckets. The number of electrons in the bucket directly indicates the amount of reflected light. In other approaches, the grayscale image is generated based on an amplitude of the measured correlation. Semi-transparent objects covering the imager introduce reflections which are unwanted in the measurement.

Hence, there may be a demand for improved intensity sensing using ToF sensors.

### SUMMARY

The demand may be satisfied by the subject matter of the appended claims.

An example relates to a method for determining an intensity value representing an intensity of light reflected from an object in a scene. The method includes performing a ToF measurement of the scene using a ToF sensor. A light-intensity-independent correlation function of a photo-sensitive pixel of the ToF sensor exhibits a plateau in a target measurement range for the ToF measurement. The object is located within the target measurement range. The method further includes determining the intensity value based on an output of the photo-sensitive pixel for the ToF measurement.

Another example relates to an apparatus for determining an intensity value representing an intensity of light reflected from an object in a scene. The apparatus includes a ToF sensor configured to perform a ToF measurement of the scene. A light-intensity-independent correlation function of a photo-sensitive pixel of the ToF sensor exhibits a plateau in a target measurement range for the ToF measurement. The object is located within the target measurement range. The apparatus additionally includes a processing circuit configured to determine the intensity value based on the output of the photo-sensitive pixel for the ToF measurement.

### BRIEF DESCRIPTION OF THE DRAWINGS

Some examples of apparatuses and/or methods will be described in the following by way of example only, and with reference to the accompanying figures, in which

FIG. 1 illustrates a flowchart of an example of a method for determining an intensity value;

FIG. 2 illustrates an example of an apparatus for determining an intensity value;

FIG. 3 illustrates an exemplary correlation function;

FIG. 4 illustrates an exemplary relation between plateau boundaries and a duty cycle of modulated light;

FIGS. 5A to 5E illustrate an exemplary relation between a correlation function and a time-shift between modulated light and a reference signal; and

FIG. 6 illustrates another exemplary correlation function.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

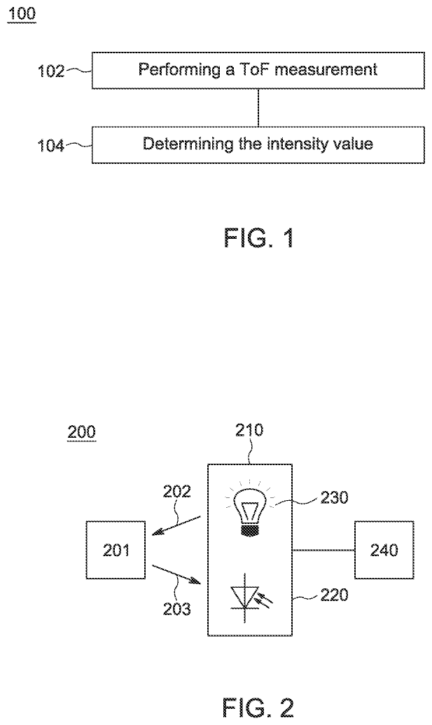

FIG. 1 illustrates a flowchart of an example of a method 100 for determining an intensity value representing an intensity of light reflected from an object in a scene. The method 100 will be described in the following further with reference to FIG. 2 which illustrates an exemplary apparatus 200 for determining an intensity value representing an intensity of light reflected from an object 201 in a scene.

The apparatus 200 comprises a ToF sensor 210. The ToF sensor 200 comprises an illumination element (circuitry, device) 230 for emitting modulated light 202 to a scene comprising the object 201 and a light capturing element (circuitry, device) 220 for capturing light 203 received from the scene.

The illumination element 230 generates the modulated light 202. The illumination element 230 may comprise any number of light sources. The illumination element 230 may, e.g., comprise one or more Light-Emitting Diodes (LEDs) and/or one or more laser diodes (e.g., one or more Vertical-Cavity Surface-Emitting Lasers, VCSELs) which are fired based on an illumination signal.

The light capturing element 220 may comprise various components such as e.g., optics (e.g., one or more lenses) and electronic circuitry. In particular, the electronic circuitry comprises an image sensor comprising at least one photo-sensitive element or pixel (e.g., comprising a Photonic Mixer Device, PMD, or a Charge-Coupled Device, CCD). For example, the image sensor may comprise a plurality of photo-sensitive elements or pixels. The at least one photo-sensitive element or pixel is driven based on a reference signal.

The method 100 comprises performing 102 a ToF measurement of the scene using the ToF sensor 210. The illumination element 230 emits the modulated light 202 to the scene during the ToF measurement. Further, the at least one photo-sensitive element or pixel is driven based on the reference signal during the ToF measurement. The reference signal exhibits an alternating series of high and low pulses of equal duration. Analogously, the modulated light 202 exhibits a series of light pulses with equal pulse length (duration) and equal pulse spacing. In other words, a Continuous Wave (CW) ToF measurement is performed.

Parameters of the ToF sensor 210 are adjusted such that a (light-intensity-independent) correlation function of the at least one photo-sensitive pixel of the ToF sensor 210 exhibits a plateau (i.e., a substantially constant value) in a target measurement range for the ToF measurement. The (light-intensity-independent) correlation function gives the photo-sensitive pixel's distance-dependent correlation of the received light 203 with the reference signal and without considering (i.e., ignoring, not taking into account) the intensity of the light 203. In other words, the (light-intensity-independent) correlation function only describes the distance-dependency of the photo-sensitive pixel's output (i.e., the dependency of the photo-sensitive pixel's output on the distance between the ToF sensor 210 and the object 201) but not the dependency of the photo-sensitive pixel's output on the intensity of the received light 203. In case the ToF sensor 210 exhibits a plurality of photo-sensitive pixels, the respective (light-intensity-independent) correlation function of each photo-sensitive pixel may be adjusted as described above.

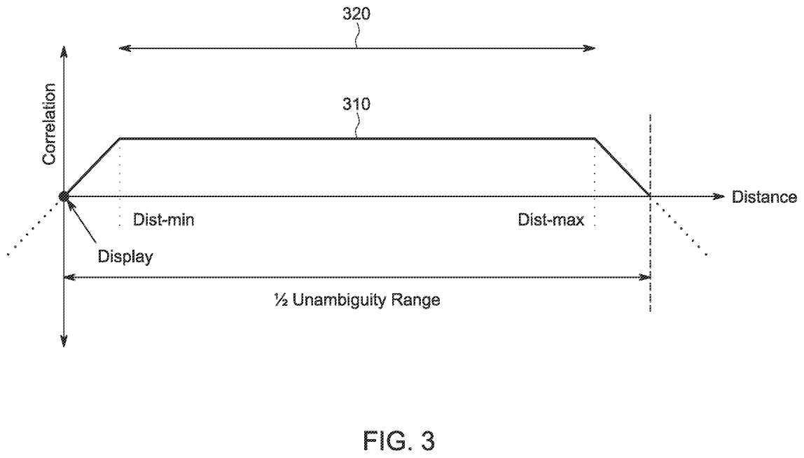

FIG. 3 illustrates an exemplary (light-intensity-independent) correlation function 310. The abscissa of FIG. 3 denotes the distance between the ToF sensor 210 and the object 201. The ordinate denotes the value of the correlation function 310. Further, the distance values “Dist-min” and “Dist-max” denote the boundaries of an exemplary target measurement range 320 of the ToF sensor 210. The object 201 is located within the target measurement range 320.

As can be seen from FIG. 3, the correlation function 310 exhibits a plateau in the target measurement range 320. In other words, the correlation function 310 is “flat” in the target measurement range 320 and, hence, exhibits substantially the same value in the target measurement range 320.

Due to the constant value of the correlation function 310 in the target measurement range 320, the ToF measurement is not sensitive to the distance between the ToF sensor 210 and the object 201 in the target measurement range 320.

The (actual) output of the ToF sensor 210's photo-sensitive pixel for the ToF measurement scales with the intensity (i.e., the light strength) of the light 203 reflected by the object 201. For example, the output by the ToF sensor 210's photo-sensitive pixel for the ToF measurement may be determined by the product of the intensity of the received light 203 during the ToF measurement and the value of the (light-intensity-independent) correlation function at the distance of the object 201 causing the received reflections. Accordingly, the output (value) of the ToF sensor 210's photo-sensitive pixel scales with the intensity of the light 203 reflected from the object 201 in case the object 201 is located within the target measurement range 320, but not with the distance between the ToF sensor 210 and the object 201. In other words, the output (value) of the ToF sensor 210's photo-sensitive pixel is proportional to the intensity of the light 203 reflected from the object 201—independent of the distance between the ToF sensor 210 and the object 201. Therefore, the output (value) of the ToF sensor 210's photo-sensitive pixel allows to characterize the intensity of the light 203 reflected from the object 201 when using a correlation function for the ToF measurement as described above.

Referring back to FIG. 1, the method 100 further comprises determining 104 an intensity value based on the output of the photo-sensitive pixel for the ToF measurement. The intensity value represents the intensity of the light 203 reflected from the object 201 in the scene. For example, determining 104 the intensity value may comprise applying at least one correction to the output (value) of the ToF sensor 210's photo-sensitive pixel for the ToF measurement. The output (value) of the ToF sensor 210's photo-sensitive pixel may, e.g., be scaled and/or offset-corrected to obtain the intensity value. Accordingly, various errors (e.g., noise) may be corrected.

The apparatus 200 comprises an accordingly configured processing circuit 240, which is coupled to the ToF sensor 210. For example, the processing circuit 240 may be a single dedicated processor, a single shared processor, or a plurality of individual processors, some of which or all of which may be shared, a digital signal processor (DSP) hardware, an application specific integrated circuit (ASIC) or a field programmable gate array (FPGA). The processing circuit 240 may optionally be coupled to, e.g., read only memory (ROM) for storing software, random access memory (RAM) and/or non-volatile memory. The processing circuit 240 is configured to determine the intensity value indicating the intensity of the light 203 reflected from the object 201 based on the output (value) of the ToF sensor 210's photo-sensitive pixel for the ToF measurement.

Although the processing circuit 240 is illustrated as a separate element in the example of FIG. 2, the processing circuit 240 may in alternative examples be integrated into the ToF sensor 210.

The processing circuit 240 may further output data indicative of the intensity value. For example, the processing circuit 240 may be configured to generate a grayscale image of the scene comprising a pixel representing the determined intensity value. The method 100 may comprise a corresponding method step. In case a plurality of the photo-sensitive pixel is used, the grayscale image of the scene may comprise a plurality of pixels each representing the determined intensity value of a respective one of the ToF sensor 210's photo-sensitive pixels. The output data of the processing circuit 240 may be used for various applications such, e.g., face recognition.

The apparatus 200 may comprise further hardware—conventional and/or custom.

In other words, a method and an apparatus for sensing the amount of light reflected by the object 201 is proposed that requires only a single measurement with the ToF sensor 210. Unlike conventional approaches, the proposed method does not require depth measurements for obtaining the intensity information. For example, the proposed method may allow to capture grayscale images more frequently than conventional approaches since it is not necessary to obtain four different raw images. The grayscale image does not require a precise “wiggling” calibration and is, hence, free from systematic error sources, which are hard to calibrate.

The target measurement range of the ToF sensor 210 depends on the modulation frequency used for the ToF measurement. In particular, the modulation frequency denotes the modulation frequency of the reference signal used for driving the ToF sensor 210's photo-sensitive pixel and of the modulated light 202 emitted to the scene during the ToF measurement. The target measurement range lies within the unambiguous distance range dᵤ as illustrated in FIG. 3. The maximum unambiguous distance range dᵤ of the ToF measurement is inversely proportional to the modulation frequency f_{mod}:

$${d}_{u} = \frac{c}{2 \cdot {f}_{mod}} \qquad ( 1 )$$

Objects measured beyond this distance are wrapped around to fall in the range [0,dᵤ), appearing much closer than they actually are. The unambiguous distance range dᵤ of the ToF measurement determines the signal range dₛᵣ for which a non-zero output of the ToF sensor 210's photo-sensitive pixel is generated:

$${d}_{sr} = \frac{{d}_{u}}{2} \qquad ( 2 )$$

The target measurement range of the ToF sensor 210 is the distance range for which valid intensity measurements are obtained, i.e., the plateau of the correlation function. The duty cycle of the modulated light 202 influences the distance range, where the correlation rises to the plateau.

The duty cycle of a signal denotes the fraction of one period during which the signal is active. For example, the duty cycle of the modulated light 203 denotes the ratio of the summed durations of the light pulses to the total period (duration) of modulated light 202. Analogously, the duty cycle of the reference signal used for driving the ToF sensor 210's photo-sensitive pixel denotes the ratio of the summed durations of the high pulses (or alternatively the low pulses) to the total period (duration) of the reference signal.

Analogously, the duty cycle of the modulated light 202 influences the distance range, where the correlation falls from the plateau. Since this correlation is symmetric, the distance range dₘᵢₙ, where the correlation rises to the plateau, can be subtracted twice from the signal range dₛᵣ to obtain the length of target measurement range dₘᵣ:

dₘᵣ=dₛᵣ−2·dₘᵢₙ (3)

The distance range dₘᵢₙ is determined by the duty cycle DC. Assuming that the duty cycle is defined between 0 and 1 (i.e., a whole period is considered), the distance range dₘᵢₙ may be defined as follows:

$${d}_{min} = \frac{DC \cdot {d}_{u}}{2} \qquad ( 4 )$$

By combining the above mathematical expressions, the length of the target measurement range dₘᵣ may be expressed as follows:

dₘᵣ=dᵤ·(0.5−DC) (5)

Accordingly, the target measurement range of the ToF sensor 210 ranges from dₘᵢₙ to dₘᵢₙ+dₘᵣ.

As can be seen from mathematical expression (5), the length of the target measurement range dₘᵣ is inversely proportional to the duty cycle DC. The lower the duty cycle DC, the greater is the length of the target measurement range dₘᵣ. Further, it can be seen from mathematical expression (5) that the duty cycle of the modulated light 202 emitted to the scene should be lower than 0.5 in order to obtain correlation function exhibiting a plateau.

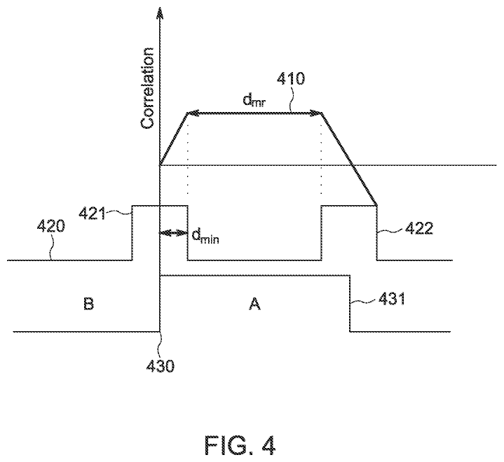

FIG. 4 schematically illustrates the relation between the plateau boundaries and the duty cycle of the emitted modulated light. FIG. 4 illustrates an exemplary (light-intensity-independent) correlation function 410 exhibiting the same shape (course) as the correlation function 310 illustrated in FIG. 3. The ordinate of FIG. 4 denotes the value of the correlation function 410. The abscissa of FIG. 4 denotes the time-shift between the light received from the object 201 and the reference signal 430 used for driving the ToF sensor 210's photo-sensitive pixel. The time-shift corresponds (is proportional) to the distance between the ToF sensor 210 and the object 201. The light received by the ToF sensor 210's photo-sensitive pixel from the object 201 is represented in FIG. 4 by a reflection 420 of the initially emitted modulated light. Like the modulated light 202 that is emitted to scene, the received reflection 420 comprises a plurality of light pulses 421, 422, . . . . The pulse length (duration) and the pulse spacing of the light pulses of the received reflection 420 is substantially identical to the pulse length and the pulse spacing of the light pulses of the emitted modulated light 202.

As illustrated for the light pulse 421, the pulse length of the light pulse 421 determines the distance range dₘᵢₙ. Analogously, the pulse length of the light pulse 422 determines the distance range, where the correlation falls from the plateau. The pulse length of the light pulses of the received reflection 420, i.e., effectively the pulse length of the emitted light 202 are determined by the duty cycle of the emitted light 202. Therefore, the position target measurement range is adjustable by the duty cycle of the emitted light 202. For example, the duty cycle of the modulated light 202 may be equal to or less than 0.45, 0.4, 0.35, 0.3, 0.25, 0.2, 0.15 or 0.1. The duty cycle of the modulated light 202 is smaller than the duty cycle of the reference signal.

The effect of the modulated light 202's duty cycle on the target measurement range is due to the internal charge separation of the ToF sensor 210's photo-sensitive pixel. As described above, the ToF sensor 210's photo-sensitive pixel is driven based on the reference signal. Depending on a signal value of the reference signal, the photo-sensitive pixel stores charges generated in the photo-sensitive pixel during the ToF measurement selectively in one of two charge storages of the photo-sensitive pixel. For example, the charge storages of the photo-sensitive pixel may be capacitors or potential wells formed in a semiconductor material of the photo-sensitive pixel. This is illustrated in FIG. 4 by means of the exemplary reference signal 430.

When the reference signal 430 is high, e.g., while the reference signal 430 exhibits the high pulse 431, the ToF sensor 210's photo-sensitive pixel stores charges generated by the received light 203 in the semiconductor material of the photo-sensitive pixel in the first one of the two charge storages. This is indicated by the letter “A” in FIG. 4 which denotes the first charge storage. When the reference signal 430 is low, the ToF sensor 210's photo-sensitive pixel stores charges generated by the received light 203 in the semiconductor material of the photo-sensitive pixel in the second one of the two charge storages. This is indicated by the letter “B” in FIG. 4 which denotes the second charge storage.

In the example of FIG. 4, the time shift between the received reflection 420 and the reference signal 430 (i.e., the distance between the ToF sensor 210 and the object 201) is such that about half of the charges generated in the semiconductor material of the photo-sensitive pixel by the respective light pulse 421, 422 goes into each of the two charge storages. Accordingly, the correlation is zero. The value of the correlation function depends on the time shift between the received reflection 420 and the reference signal 430 and, hence, the distance between the ToF sensor 210 and the object 201.

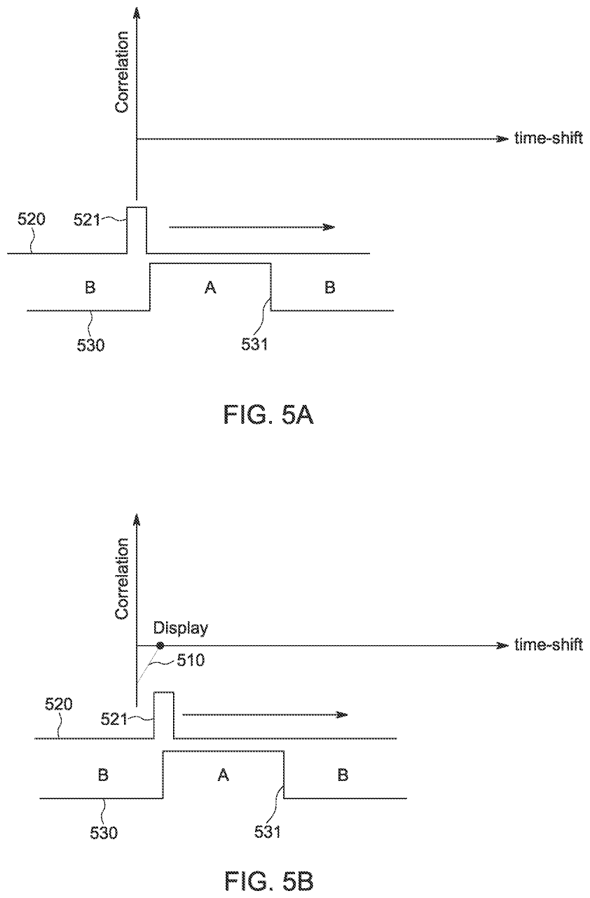

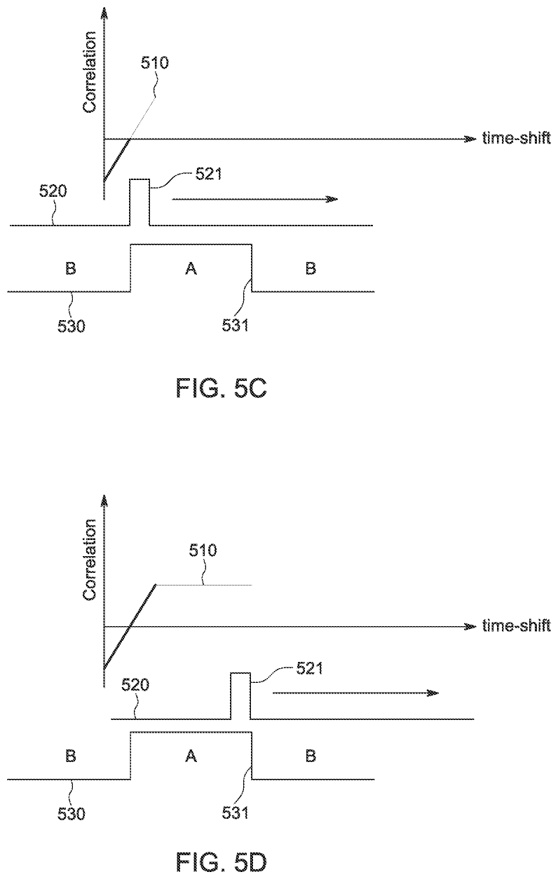

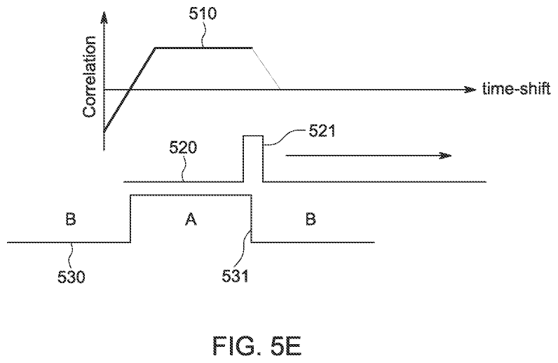

This is further illustrated in FIGS. 5A to 5E showing the relation between the value of the correlation function and the time shift between the received light and the reference signal used for driving the ToF sensor 210's photo-sensitive pixel. The ordinate in each of FIGS. 5A to 5E denotes the value of the correlation function. The abscissa in each of FIGS. 5A to 5E denotes the time-shift between the light received from the object 201 and the reference signal 530 used for driving the ToF sensor 210's photo-sensitive pixel. The time-shift corresponds (is proportional) to the distance between the ToF sensor 210 and the object 201. The light received by the ToF sensor 210's photo-sensitive pixel from the object 201 is represented in FIGS. 5A to 5E by a reflection 520 of the initially emitted modulated light.

Analogously to the example of FIG. 4, the ToF sensor 210's photo-sensitive pixel stores charges generated in a semiconductor material of the photo-sensitive pixel by the reflection 520 (i.e., the received light) in the first one of the two charge storages, when the reference signal 530 is high, e.g., while the reference signal 530 exhibits the high pulse 531. This is again indicated by the letter “A” in FIG. 5 which denotes the first charge storage. When the reference signal 530 is low, the ToF sensor 210's photo-sensitive pixel stores charges generated in the semiconductor material of the photo-sensitive pixel by the reflection 520 (i.e., the received light) in the second one of the two charge storages. This is indicated by the letter “B” in FIG. 5 which denotes the second charge storage.

In FIG. 5A, the object 201 is arranged outside the target measurement range. Accordingly, the time shift between the received reflection 520 and the reference signal 530 is such that charges generated by the light pulse 521 (of the reflection 520) in the semiconductor material of the photo-sensitive pixel are stored in the second one of the two charge storages, i.e., the charge storage B.

In FIG. 5B, the distance of the object 201 to the ToF sensor 210 is increased but the object 201 is not yet in the target measurement range. Analogously to the example of FIG. 4, the time shift between the received reflection 520 and the reference signal 530 is such that about half of the charges generated in the semiconductor material of the photo-sensitive pixel by the light pulse 521 goes into each of the two charge storages. Accordingly, the correlation is zero. The correlation function 510 increases as more and more of the generated charges are stored in the charge storage A.

As the correlation is substantially zero at this specific distance, an element covering the ToF sensor 210 may be arranged at this distance with respect to the ToF sensor 210. For example, a cover glass or a display covering the ToF sensor 210 may be arranged at this distance such that reflections of the emitted light 202 from this element do not influence the ToF measurement. In general, an element covering the ToF sensor 210 may be arranged at any predetermined distance with respect to the ToF sensor 210 for which an absolute value of the (light-intensity-independent) correlation function is less than 10%, 5% or 1% of an absolute value of the (light-intensity-independent) correlation function at the plateau. For example, the placement of a display covering the ToF sensor 210 at a distance for which the correlation is substantially zero is further indicated in the left part of FIG. 3.

Further, it is to be noted that the above is not limited to elements covering the ToF sensor 210. In general, the (light-intensity-independent) correlation function may be designed such that an absolute value of the light-intensity-independent correlation function is at any predetermined (target, desired) distance less than 10%, 5% or 1% of an absolute value of the light-intensity-independent correlation function at the plateau. For example, if another unwanted (disturbing) object is located in the scene at a certain distance with respect to the ToF sensor 210, the (light-intensity-independent) correlation function may be designed such that an absolute value of the light-intensity-independent correlation function at this distance is less than 10%, 5% or 1% of an absolute value of the light-intensity-independent correlation function at the plateau. Accordingly, reflections of the emitted light that are received from the unwanted object effectively do not influence the ToF measurement for the object 201.

As described above, the amount of charge stored in the charge storage A increases with increasing distance of the object 201 to the ToF sensor 210. The distance from which on all generated charges are stored in the charge storage A denotes one of the boundaries of the correlation function 510's plateau and, hence, one of the boundaries of the target measurement range. This is illustrated in FIG. 5C. In FIG. 5C, charges are no longer stored in the charge storage B, they are only stored in the charge storage A. The smaller the light pulse 521 is, i.e., the lower the duty cycle of the emitted modulated light 202 is, the smaller is distance from which on all generated charges are stored in the charge storage A.

As long as the object 201 is in the target measurement region, the charges generated by the light pulse 521 are stored in the charge storage A. The length of the correlation function 510's plateau and, hence, the target measurement region, is determined by the modulation frequency of the emitted modulated light 203 and the reference signal 530. The lower the modulation frequency is, the longer is the length of the correlation function 510's plateau. This is illustrated in FIG. 5D.

The distance from which on the generated charges are no longer stored only in the charge storage A denotes the other boundary of the correlation function 510's plateau and, hence, the other boundary of the target measurement range. This is illustrated in FIG. 5E. The distance of the object 201 to the ToF sensor 210 is increased further such the object 201 is exiting the target measurement range. Accordingly, more and more of the generated charges are stored in the charge storage B and fewer charges are stored in the charge storage A such that the correlation function falls from the plateau. In the example of FIG. 5E, the time shift between the received reflection 520 and the reference signal 530 is such that about half of the charges generated in the semiconductor material of the photo-sensitive pixel by the light pulse 521 goes into each of the two charge storages. Accordingly, the correlation is zero. For example, the distance for which the correlation function 510 is again zero may be selected to minimize the influence on the ToF measurement of reflections received from an unwanted (disturbing) object located at this distance in the scene.

For obtaining the output (value) of the ToF sensor 210's photo-sensitive pixel, various read-out approaches are possible. For example, the output of the photo-sensitive pixel for the ToF measurement may be based on (determined by) only the charges collected in one of the two charge storages during the ToF measurement. The output (value) of the photo-sensitive pixel for the ToF measurement may, e.g., be based on only the charges stored in the charge storage A but not the charges stored in the charge storage B in the examples of FIGS. 4 and 5A to 5E. In alternative examples, the output (value) of the photo-sensitive pixel for the ToF measurement may be based on (determined by) a difference between the charges collected in the two charge storages during the ToF measurement. The output (value) of the photo-sensitive pixel for the ToF measurement may, e.g., be based on the amount of charge C_{A} stored in the stored in the charge storage A minus the amount of charge C_{B} stored in the charge storage B in the examples of FIGS. 4 and 5A to 5E. Basing the output (value) of the photo-sensitive pixel for the ToF measurement on the difference between the charges collected in the two charge storages may allow to reduce background light effects and, hence, improve the accuracy of the photo-sensitive pixel's output (value).

Summarizing the above, a single measurement with a rather untypical CW modulation is proposed. As described above, the position of the correlation may be tuned such that the zero crossing is at the position of disturbing objects such as a display or a cover glass. The duty cycle is tuned to generate the plateau of the correlation function. The measurement range is within the plateau. Since the correlation is constant at the plateau, the obtained values correspond to the received signal strength, which is the same as in grayscale images. The minimum distance (Dist-min in FIG. 3) and the maximum distance (Dist-max in FIG. 3) defining the plateau are both dependent on the used modulation frequency. In the area of the plateau, an intensity measurement is possible.

In order to get rid of systematic measurement errors, another ToF measurement may be performed in addition. The reference signal used for driving the ToF sensor 210's photo-sensitive pixel in the other ToF measurement is inverted with respect to the reference signal used for driving the photo-sensitive pixel in the (above described initial) ToF measurement. In other words, the reference signal for the other ToF measurement is phase shifted by 180° with respect to the reference signal for the initial ToF measurement. Accordingly, the intensity value may be determined based on the difference between the output (value) of the ToF sensor 210's photo-sensitive pixel for the ToF measurement and the output (value) of the ToF sensor 210's photo-sensitive pixel for the other ToF measurement.

The target measurement range may be determined at runtime using the ToF sensor. For example, one or more one or more further ToF measurements may be performed using the ToF sensor 210. A distance value indicating the distance of the ToF sensor 210 to the object 201 may be determined based on the output (value(s)) of the ToF sensor for the one or more further ToF measurements. The distance value may be determined according to conventional ToF depth sensing principles based on the output (value(s)) of the ToF sensor for the one or more further ToF measurements. Accordingly, the target measurement range may be determined based on the distance value such that the object 201 is within the target measurement range.

Optionally, it may be determined whether further objects (i.e., objects in addition to the object 201) are present in the scene based on the output (value(s)) of the ToF sensor for the one or more further ToF measurements. In case it is determined that further objects are present in scene, the parameters of the ToF sensor 210 may be adjusted such that a respective absolute value of the (light-intensity-independent) correlation function at the respective distance of the one or more further objects is less than 10% of an absolute value of the (light-intensity-independent) correlation function at the plateau.

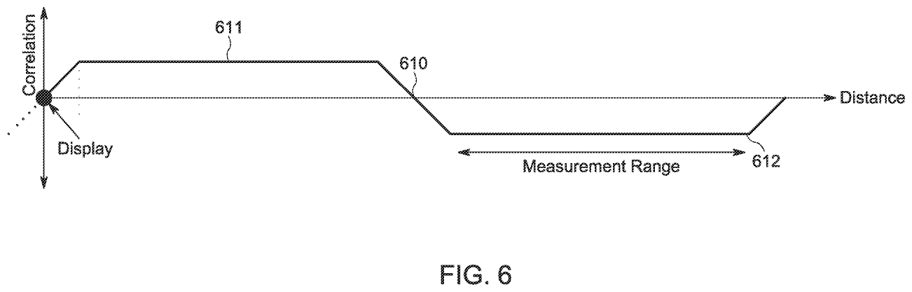

In case the object 201 is located further away from the ToF sensor, the (light-intensity-independent) correlation function may be designed to comprise one or more further plateaus instead of extending the first plateau by lowering the modulation frequency. This is exemplarily illustrated in FIG. 6. FIG. 6 illustrates an exemplary (light-intensity-independent) correlation function 610. The abscissa of FIG. 6 denotes the distance between the ToF sensor 210 and the object 201. The ordinate denotes the value of the correlation function 610.

The correlation function 610 exhibits a first plateau 611 similar to the correlation functions 310 and 410 illustrated in FIGS. 3 and 4. The first plateau 611 corresponds to a first target measurement range for the ToF measurement. In addition, the correlation function 610 exhibits a second plateau 612 corresponding to a second target measurement range for the ToF measurement.

Optionally, the correlation function 610 may comprise further plateaus corresponding to further target measurement ranges for the ToF measurement. In general, a (light-intensity-independent) correlation function according to the present disclosure may exhibit at least one further plateau in at least one further target measurement range for the ToF measurement.

In case the object is located in a target measurement range corresponding to a plateau with a negative value, the output (value) of the ToF sensor 210's photo-sensitive pixel may be corrected (e.g., multiplied with −1) to obtain the intensity value.

As indicated in FIG. 6, the zero-crossings of the correlation function 610 may be selected such that they are positioned at distances of disturbing objects such as a display covering the ToF sensor 210.

In other examples, multiple ToF measurements may be performed to cover multiple target measurement ranges. For example, a ToF measurement may be performed as described above to obtain an output (value) of the ToF sensor 210's photo-sensitive pixel for a first target measurement range. Additionally, another ToF measurement of the scene may be performed using the ToF sensor. The (light-intensity-independent) correlation function of the photo-sensitive pixel exhibits for the other ToF measurement a plateau in another second target measurement range. The (light-intensity-independent) correlation function for the first ToF measurement may, e.g., only comprise the plateau 611 illustrated in FIG. 6 and the other (light-intensity-independent) correlation function for the second ToF measurement may, e.g., only comprise the plateau 612 illustrated in FIG. 6. Accordingly, two target measurement ranges may be covered with two ToF measurements.

The intensity value may be determined based on the output (value) of the photo-sensitive pixel for the ToF measurement and the output (value) of the photo-sensitive pixel for the other ToF measurement. For example, the outputs (output values) for both ToF measurements may be added and optionally be scaled to obtain the intensity value.

Optionally further ToF measurements with (light-intensity-independent) correlation functions exhibiting a respective plateau in further target measurement ranges may be used.

The examples as described herein may be summarized as follows:

Some examples relate to a method for determining an intensity value representing an intensity of light reflected from an object in a scene. The method comprises performing a ToF measurement of the scene using a ToF sensor. A light-intensity-independent correlation function of a photo-sensitive pixel of the ToF sensor exhibits a plateau in a target measurement range for the ToF measurement. The object being located within the target measurement range. The method further comprises determining the intensity value based on an output of the photo-sensitive pixel for the ToF measurement.

In some examples, the light-intensity-independent correlation function gives the photo-sensitive pixel's distance-dependent correlation of the light with a reference signal and without considering the intensity of the light, the photo-sensitive pixel being driven based on the reference signal.

According to some examples, determining the intensity value comprises applying at least one correction to the output of the photo-sensitive pixel for the ToF measurement.

In some examples, performing the ToF measurement comprises: illuminating the scene with modulated light; and driving the photo-sensitive pixel based on a reference signal, wherein the reference signal exhibits an alternating series of high and low pulses of equal duration, and wherein the modulated light exhibits a series of light pulses with equal pulse length and equal pulse spacing.

According to some examples, a duty cycle of the modulated light is smaller than a duty cycle of the reference signal.

In some examples, the method further comprises performing another ToF measurement, wherein the reference signal used for driving the photo-sensitive pixel in the other ToF measurement is inverted with respect to the reference signal used for driving the photo-sensitive pixel in the ToF measurement, and wherein the intensity value is determined based on a difference between the output of the photo-sensitive pixel for the ToF measurement and an output of the photo-sensitive pixel for the other ToF measurement.

According to some examples, depending on a signal value of the reference signal, the photo-sensitive pixel stores charges generated in the photo-sensitive pixel during the ToF measurement selectively in one of two charge storages of the photo-sensitive pixel, and wherein the output of the photo-sensitive pixel for the ToF measurement is based on only the charges collected in one of the two charge storages during the ToF measurement.

In alternative examples, depending on a signal value of the reference signal, the photo-sensitive pixel stores charges generated in the photo-sensitive pixel during the ToF measurement selectively in one of two charge storages of the photo-sensitive pixel, and wherein the output of the photo-sensitive pixel for the ToF measurement is based on a difference between the charges collected in the two charge storages during the ToF measurement.

In some examples, the light-intensity-independent correlation function exhibits at least one further plateau in at least one further target measurement range for the ToF measurement.

According to some examples, the method further comprises: performing another ToF measurement of the scene using the ToF sensor, wherein the light-intensity-independent correlation function of the photo-sensitive pixel exhibits for the other ToF measurement a plateau in another target measurement range; and determining the intensity value based on the output of the photo-sensitive pixel for the ToF measurement and an output of the photo-sensitive pixel for the other ToF measurement.

In some examples, an absolute value of the light-intensity-independent correlation function at a predetermined distance is less than 10% of an absolute value of the light-intensity-independent correlation function at the plateau.

According to some examples, an element covering the ToF sensor is arranged at the predetermined distance with respect to the ToF sensor.

In some examples, the method further comprises: performing one or more further ToF measurements using the ToF sensor; determining a distance value indicating a distance to the object based on an output of the ToF sensor for the one or more further ToF measurements; and determining the target measurement range based on the distance value.

According to some examples, the method further comprises generating a grayscale image of the scene comprising a pixel representing the determined intensity value.

Other examples relate to an apparatus for determining an intensity value representing an intensity of light reflected from an object in a scene. The apparatus comprises a ToF sensor configured to perform a ToF measurement of the scene. A light-intensity-independent correlation function of a photo-sensitive pixel of the ToF sensor exhibits a plateau in a target measurement range for the ToF measurement. The object is located within the target measurement range. The apparatus additionally comprises a processing circuit configured to determine the intensity value based on the output of the photo-sensitive pixel for the ToF measurement.

Examples of the present disclosure may enable ToF grayscale imaging while removing the reflective influence of a display or another close object.

The aspects and features described in relation to a particular one of the previous examples may also be combined with one or more of the further examples to replace an identical or similar feature of that further example or to additionally introduce the features into the further example.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. A method for determining an intensity value representing an intensity of light reflected from an object in a scene, the method comprising:
performing a Time-of-Flight (ToF) measurement of the scene using a ToF sensor, wherein a light-intensity-independent correlation function of a photo-sensitive pixel of the ToF sensor exhibits a plateau in a target measurement range for the ToF measurement, the object being located within the target measurement range; and
determining the intensity value based on an output of the photo-sensitive pixel for the ToF measurement.

2. The method of claim 1, wherein the light-intensity-independent correlation function provides the photo-sensitive pixel's distance-dependent correlation of the light with a reference signal without considering the intensity of the light, wherein the photo-sensitive pixel is driven based on the reference signal.

3. The method of claim 1, wherein determining the intensity value comprises applying at least one correction to the output of the photo-sensitive pixel for the ToF measurement.

4. The method of claim 1, wherein performing the ToF measurement comprises:
illuminating the scene with modulated light; and
driving the photo-sensitive pixel based on a reference signal,
wherein the reference signal exhibits an alternating series of high and low pulses of equal duration, and
wherein the modulated light exhibits a series of light pulses with equal pulse length and equal pulse spacing.

5. The method of claim 4, wherein a duty cycle of the modulated light is smaller than a duty cycle of the reference signal.

6. The method of claim 4, wherein the method further comprises:
performing a further ToF measurement, wherein the reference signal used for driving the photo-sensitive pixel in the further ToF measurement is inverted with respect to the reference signal used for driving the photo-sensitive pixel in the ToF measurement, and wherein the intensity value is determined based on a difference between the output of the photo-sensitive pixel for the ToF measurement and an output of the photo-sensitive pixel for the further ToF measurement.

7. The method of claim 4, wherein, depending on a signal value of the reference signal, the photo-sensitive pixel stores charges generated in the photo-sensitive pixel during the ToF measurement selectively in one of two charge storages of the photo-sensitive pixel, and wherein the output of the photo-sensitive pixel for the ToF measurement is based on only the charges collected in one of the two charge storages during the ToF measurement.

8. The method of claim 4, wherein, depending on a signal value of the reference signal, the photo-sensitive pixel stores charges generated in the photo-sensitive pixel during the ToF measurement selectively in one of two charge storages of the photo-sensitive pixel, and wherein the output of the photo-sensitive pixel for the ToF measurement is based on a difference between the charges collected in the two charge storages during the ToF measurement.

9. The method of claim 1, wherein the light-intensity-independent correlation function exhibits at least one further plateau in at least one further target measurement range for the ToF measurement.

10. The method of claim 1, further comprising:
performing a further ToF measurement of the scene using the ToF sensor, wherein the light-intensity-independent correlation function of the photo-sensitive pixel exhibits for the further ToF measurement a plateau in another target measurement range; and
determining the intensity value based on the output of the photo-sensitive pixel for the ToF measurement and an output of the photo-sensitive pixel for the further ToF measurement.

11. The method of claim 1, wherein an absolute value of the light-intensity-independent correlation function at a predetermined distance is less than 10% of an absolute value of the light-intensity-independent correlation function at the plateau.

12. The method of claim 11, wherein an element covering the ToF sensor is arranged at the predetermined distance with respect to the ToF sensor.

13. The method of claim 1, further comprising:
performing one or more further ToF measurements using the ToF sensor;
determining a distance value indicating a distance to the object based on an output of the ToF sensor for the one or more further ToF measurements; and
determining the target measurement range based on the distance value.

14. The method of claim 1, further comprising:
generating a grayscale image of the scene comprising a pixel representing the determined intensity value.

15. An apparatus for determining an intensity value representing an intensity of light reflected from an object in a scene, the apparatus comprising:
a Time-of-Flight (ToF) sensor configured to perform a ToF measurement of the scene, wherein a light-intensity-independent correlation function of a photo-sensitive pixel of the ToF sensor exhibits a plateau in a target measurement range for the ToF measurement, the object being located within the target measurement range; and
a processing circuit configured to determine the intensity value based on the output of the photo-sensitive pixel for the ToF measurement.
